(19) United States
(12) Patent Application Publication
(10) Pub. No.: US 2025/0371284 A1
(43) Pub. Date: Dec. 4, 2025

(54) USER AND OPERATOR PREFERENCE RECONCILIATION FOR PRE-PROMPT ENGINEERING

(71) Applicant: Insight Direct USA, Inc., Chandler, AZ (US)

(72) Inventors: David McCurdy, Centennial, CO (US); Jason Rader, Jacksonville, FL (US)

(21) Appl. No.: 18/911,903

(22) Filed: Oct. 10, 2024

Related U.S. Application Data
(60) Provisional application No. 63/655,950, filed on Jun. 4, 2024.

(51) Int. Cl. G06F 40/40; G06N 5/02

(52) U.S. Cl. CPC G06F 40/40; G06N 5/027

(57) ABSTRACT

A method of language generation includes, by a server, receiving from a user device a plurality of user preferences for natural-language outputs generated by a machine-learning language model based on user-provided natural-language text inputs and a natural-language text prompt provided by the user to a chat application operating on the user device, receiving a plurality of operator preferences for the natural-language outputs, generating a set of reconciled preferences according to a rules engine, modifying a system prompt for the machine-learning language model based on the set of reconciled preferences to generate a modified system prompt, providing the modified system prompt as an initial input to the machine-learning language model, and providing the natural-language text prompt as an input to the machine-learning language model to generate a natural-language text output. The set of reconciled preferences includes fewer than all of the plurality of operator preferences and the plurality of user preferences.

### CROSS-REFERENCE TO RELATED APPLICATION

This application is a nonprovisional application claiming the benefit of U.S. provisional Ser. No. 63/655,950, filed on Jun. 4, 2024, entitled “USER AND OPERATOR PREFERENCE RECONCILIATION FOR PRE-PROMPT ENGINEERING” by D. McCurdy and J. Rader.

### FIELD OF THE INVENTION

The present disclosure relates to user-specific language generation and, more particularly, to systems and methods for creating system prompts based on user and operator preferences for use with artificial intelligence models for language generation.

### BACKGROUND

Generative artificial intelligence (AI) language models, such as large language models and/or transformer models, are capable of dynamically generating content based on user prompts. Some language models are capable of generating human-like text and can be incorporated into text chat programs in order to mimic the experience of interacting with a human in a text chat. Language models can use a system prompt (sometimes referred to as a pre-prompt or internal prompt) to define roles and provide other instructions and/or constraints for language generation.

### SUMMARY

An example of a method of language generation includes, by a server, receiving from a user device a plurality of user preferences for natural-language outputs generated by a machine-learning language model based on user-provided natural-language text inputs and a natural-language text prompt provided by the user to a chat application operating on the user device. The plurality of user preferences are provided by a user of the user device. The method further includes, by the server, receiving a plurality of operator preferences for the natural-language outputs determined by an operator of the server, generating a set of reconciled preferences according to a rules engine, modifying a system prompt for the machine-learning language model based on the set of reconciled preferences to generate a modified system prompt, providing the modified system prompt as an initial input to the machine-learning language model, providing the natural-language text prompt as an input to the machine-learning language model to generate a natural-language text output, and transmitting the natural-language text output to the user device. The set of reconciled preferences includes fewer than all of the plurality of operator preferences and the plurality of user preferences. The method further includes communicating, by the chat application and via the user device, the natural-language text output to the user.

An example of a system for language generation includes a user device comprising a first processor and at least one first memory, and further includes a remote device communicatively connected to the user device and including a second processor and at least one second memory. The at least one first memory stores a plurality of user preferences for natural-language outputs generated by a machine-learning language model based on user-provided natural-language text inputs. The plurality of user preferences are determined by a user of the user device. The at least one first memory is also encoded with first instructions that, when executed, cause the first processor to provide the natural-language text string as a natural-language text prompt to a chat application operating on the user device and receive a natural-language text prompt. The at least one second memory is encoded with second instructions that, when executed, cause the second processor to receive the natural language text prompt from the user device, receive the plurality of user preferences from the user device, receive a plurality of operator preferences for the natural-language outputs, modify a system prompt for the machine-learning language model based on the set of reconciled preferences to generate a modified system prompt, provide the modified system prompt as an initial input to the machine-learning language model and, provide, after modifying the system prompt, the natural-language text prompt as a subsequent input to the machine-learning language model to generate a natural-language text output. The second instructions, when executed, further cause the remote device to transmit the natural-language text output to the user device. The plurality of operator preferences are determined by an operator of the server, generate a set of reconciled preferences by according to a rules engine and the set of reconciled preferences includes fewer than all of the plurality of operator preferences and the plurality of user preferences

The present summary is provided only by way of example, and not limitation. Other aspects of the present disclosure will be appreciated in view of the entirety of the present disclosure, including the entire text, claims, and accompanying figures.

### BRIEF DESCRIPTION OF THE DRAWINGS

FIG. 1 is a schematic diagram of an example of a system for reconciling user and operator preferences and generating custom system prompts based on those reconciled preferences, and further for generating natural language based on those custom system prompts.

FIG. 2 is a schematic diagram of another example of a system for reconciling user and operator preferences and generating custom system prompts based on those reconciled preferences, and further for generating natural language based on those custom system prompts.

FIG. 3 is a flow diagram of an example of a method of reconciling user and operator preferences and generating custom system prompts based on those reconciled preferences, and further for generating natural language based on those custom system prompts suitable for use by the systems of FIGS. 1-2.

FIG. 4 is a flow diagram of an example of a method of training a computer-implemented machine learning model suitable for use with the method of FIG. 3.

While the above-identified figures set forth one or more examples of the present disclosure, other examples are also contemplated, as noted in the discussion. In all cases, this disclosure presents the invention by way of representation and not limitation. It should be understood that numerous other modifications and examples can be devised by those skilled in the art, which fall within the scope and spirit of the principles of the invention. The figures may not be drawn to scale, and applications and examples of the present invention may include features and components not specifically shown in the drawings.

### DETAILED DESCRIPTION

The present disclosure relates to systems and methods for generating and using user- and operator-specific system prompts. In particular, the present disclosure relates to systems and methods for the automated and reconciliation of conflicts between user and operator preferences and, further, for the automated generation of custom system prompts based on reconciled user and operator preference information. The custom system prompts generated using the methods and systems herein can be used to improve natural-language responses generated by machine-learning language models in response to user-generated natural-language prompts. In particular, the user- and operator-specific system prompts increase the likelihood that machine-generated natural-language is relevant to a user, improving user experience and increasing user retention, and also enable an operator's (e.g., an operator of a language generation service based on a machine-learning language model) preferences, goals, desires, etc. to also be reflected in language generation. As will be explained in more detail subsequently, the use of system prompts that incorporate both user and operator preferences enables language generation that improves user experience while enabling operators of machine-learning language model-powered language generation services to advance specific goals in language generation and seek out revenue streams related to those goals. Further, as will also be explained in more detail subsequently, the reconciliation of operator and user preferences provided by the systems and method described herein decreases the likelihood that incongruous preferences are described in a system prompt that incorporates preference information from multiple sources (i.e., from users and operators of a language generation service), thereby reducing the likelihood that conflicts between user and operator preferences result in a confusing, incoherent, or otherwise degraded output from a machine-learning language model provided with those preferences via a custom system prompt.

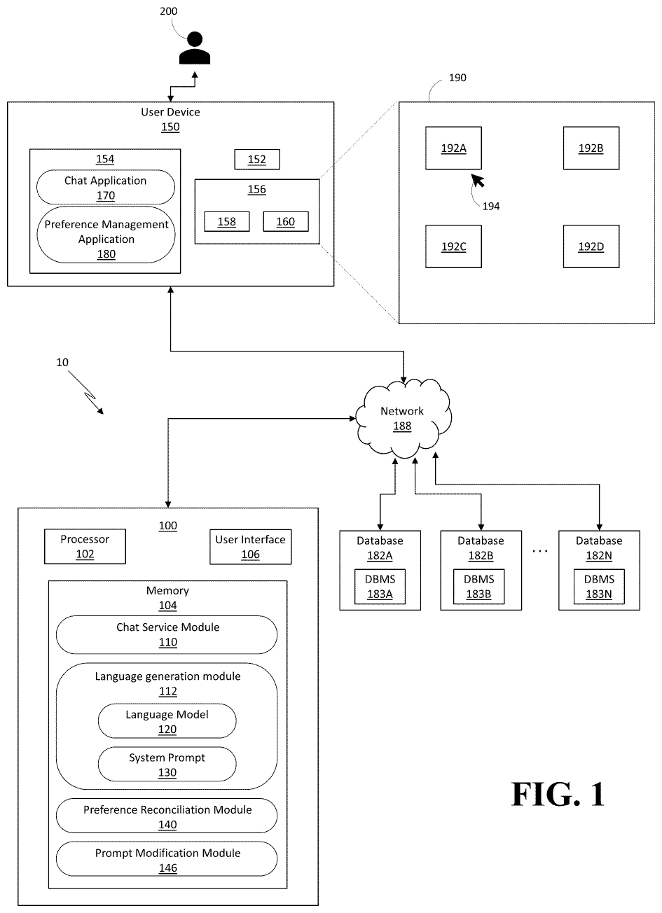

FIG. 1 is a schematic depiction of system 10, which is a system for generating natural-language responses to user-generated prompts. System 10 includes server 100, user device 150, databases 182A-N, and network 188. Server 100 includes processor 102, memory 104, and user interface 106. Memory 104 stores chat service module 110, language generation module 112, preference reconciliation module 140, and prompt modification module 146. Language generation module 112 includes language model 120 and system prompt 130. User device 150 includes processor 152, memory 154, and user interface 156. User interface 156 optionally includes both input device 158 and output device 160. Memory 154 includes chat application 170 and preference management application 180. Databases 182A-N organize data using database management systems (DBMSs) 183A-N, respectively. Preference management application 180 provides graphical user interface 190, which can be communicated to a user via user interface 156. Graphical user interface 190 includes graphical objects 192A-N, which are selectable using pointer 194. FIG. 1 also depicts user 200.

Server 100 operates a chat service that uses a machine-learning language model to generate natural-language responses to user-generated prompts. As will be explained in more detail subsequently, the natural-language responses generated by server 100 are based in part on user preferences stored to user device 150 and/or one or more of databases 182A-N as well as operator preferences stored to one or more of databases 182A-N. As referred to herein, a “user preference” is a preference of a user of the chat service operated by server 100 (e.g., 200) regarding one or more characteristics of the outputs produced by server 100. As referred to herein, an “operator preference” is a preference of the operator of the chat service (e.g., the operator of server 100) regarding one or more characteristics of the outputs produced by server 100.

User preference and operator preference information is used by server 100 to generate custom system prompts that reflect interests of both users and operators of the chat service operated by chat service module 110 of server 100. The custom system prompts can be used as an initial input prior to language generation by language model 120 based on user prompts. The system prompt can be changed or modified for each user accessing language-generation functionality of server 100 (e.g., for each instance of language-generation software operating on server 100), allowing for robust incorporation of user and operator preferences in language generation.

Server 100 is connected to network 188 via one or more wired and/or wireless connections and is able to communicate with user device 150 via network 188. In some examples, server 100 can be referred to as a “remote device” and/or a “remotely-connected device.” Although server 100 is generally referred to herein as a server, server 100 can be any suitable network-connectable computing device for performing the functions of server 100 detailed herein.

Processor 102 can execute software, applications, and/or programs stored on memory 104. Examples of processor 102 can include one or more of a processor, a microprocessor, a controller, a digital signal processor (DSP), an application specific integrated circuit (ASIC), a field-programmable gate array (FPGA), or other equivalent discrete or integrated logic circuitry. Processor 102 can be entirely or partially mounted on one or more circuit boards.

Memory 104 is configured to store information and, in some examples, can be described as a computer-readable storage medium. Memory 104, in some examples, is described as computer-readable storage media. In some examples, a computer-readable storage medium can include a non-transitory medium. The term “non-transitory” can indicate that the storage medium is not embodied in a carrier wave or a propagated signal. In certain examples, a non-transitory storage medium can store data that can, over time, change (e.g., in RAM or cache). In some examples, memory 104 is a temporary memory. As used herein, a temporary memory refers to a memory having a primary purpose that is not long-term storage. Memory 104, in some examples, is described as volatile memory. As used herein, a volatile memory refers to a memory that that the memory does not maintain stored contents when power to the memory 104 is turned off. Examples of volatile memories can include random access memories (RAM), dynamic random access memories (DRAM), static random access memories (SRAM), and other forms of volatile memories. In some examples, the memory is used to store program instructions for execution by the processor. Memory 104, in one example, is used by software or applications running on server 100 (e.g., by a computer-implemented machine-learning model) to temporarily store information during program execution.

Memory 104, in some examples, also includes one or more computer-readable storage media. Memory 104 can be configured to store larger amounts of information than volatile memory. Memory 104 can further be configured for long-term storage of information. In some examples, memory 104 includes non-volatile storage elements. Examples of such non-volatile storage elements can include, for example, magnetic hard discs, optical discs, floppy discs, flash memories, or forms of electrically programmable memories (EPROM) or electrically erasable and programmable (EEPROM) memories.

User interface 106 is an input and/or output device and/or software interface, and enables an operator to control operation of and/or interact with software elements of server 100. For example, user interface 106 can be configured to receive inputs from an operator and/or provide outputs. User interface 106 can include one or more of a sound card, a video graphics card, a speaker, a display device (such as a liquid crystal display (LCD), a light emitting diode (LED) display, an organic light emitting diode (OLED) display, etc.), a touchscreen, a keyboard, a mouse, a joystick, or other type of device for facilitating input and/or output of information in a form understandable to users and/or machines.

In some examples, server 100 can operate an application programming interface (API) for facilitating communication between server 100 and other devices connected to network 188 as well as for allowing devices connected to network 188 to access functionality of server 100. A device connected to network 188, such as user device 150, can send a request to an API operated by server 100 to, for example, generate language using language model 120 and/or modify the content of system prompt 130.

User device 150 is an electronic device that a user (e.g., user 200) can use to access network 188 and functionality of server 100 (i.e., via network 188). User device 150 includes processor 152, memory 154, and user interface 156, which are substantially similar to processor 102, memory 104, and user interface 106, respectively, and the discussion herein of processor 102, memory 104, and user interface 106 is applicable to processor 152, memory 154, and user interface 156, respectively. User device 150 includes networking capability for sending and receiving data transmissions via network 188 and can be, for example, a personal computer or any other suitable electronic device for performing the functions of user device 150 detailed herein. Memory 154 stores software elements of chat application 170 and preference management application 180, which will be discussed in more detail subsequently and particularly with respect to the function of chat server module 110 of server 100.

User interface 156 optionally includes one or both of input device 158 and output device 160. Input device 158 is a device that a user (e.g., user 200) can use to provide inputs to the program(s) of user device 150. Input device 158 can be, for example, a touchscreen, a keyboard, a mouse, a joystick, etc. A user can use input device 158 to, for example, provide inputs to chat application 170 and preference management application 180. Output device 160 is a device for communicating outputs from the program(s) of user device 150 to a user (e.g., user 200). Output device 160 can include, for example, one or more of a display, a speaker, or any other suitable device for conveying outputs from the program(s) of user device 150.

Databases 182A-N are electronic databases that are directly connected to server 100 and/or are connected to server 100 via a local network. Each of databases 182A-N includes machine-readable data storage capable of retrievably housing stored data, such as database or application data. In some examples, one or more of databases 182A-N includes long-term non-volatile storage media, such as magnetic hard discs, optical discs, flash memories and other forms of solid-state memory, or forms of electrically programmable memories (EPROM) or electrically erasable and programmable (EEPROM) memories. Databases 182A-N organize data using DBMSs 183A-N, respectively and can each include a processor, at least one memory, and a user interface that are substantially similar to processor 102, memory 104, and user interface 106 of server 100. In at least some examples, one or more of databases 182A-N are relational databases. Each of databases 182A-N can be a structured database (e.g., a table or relational database) or a semi-structured database (e.g., a hierarchical and/or nested database). Databases 182A-N store data describing users who access server 100 and the software modules thereof (e.g., user 200), user preferences (i.e., preference information provided through preference management application 180), and/or operator preference information. In some examples, databases 182A-N can store operator preference information for each known user of server 100, such that identifying information for a user (e.g., a user identifier) can be used to query one or more databases 182A-N to return the operator preference information selected for that particular user. Advantageously, in these examples, operator preference information can be customized on a user-by-user basis, such that different operator preferences can be pre-determined and applied to different users and/or user groups accessing server 100.

DBMSs 183A-N are database management systems. As used herein, a “database management system” refers to a system of organizing data stored on a data storage medium. In some examples, a database management system described herein is configured to run operations on data stored on the data storage medium. The operations can be requested by a user and/or by another application, program, and/or software. The database management system can be implemented as one or more computer programs stored on at least one memory device and executed by at least one processor to organize and/or perform operations on stored data. In at least some examples, each of DBMSs 183A-N is different from the others of DBMSs 183A-N, such that each of databases 182A-N organizes data in a different manner than the others of databases 182A-N.

Network 188 is a network suitable for connecting and facilitating network communication between server 100, user device 150, and databases 182A-N. Network 188 can include any suitable combination of local network and wide area network (WAN) elements or components to connect server 100, user device 150, and databases 182A-N. In some examples, the wide area network can be or include the Internet. For example, server 100 can be connected to databases 182A-N via a local network and server 100 can be connected to user device 150 via a WAN. As a further example, server 100 can be connected to all of user device 150 and databases 182A-N via a WAN. In yet further examples, server 100 can be connected to some of databases 182A-N via a WAN and others of databases 182A-N via a local network.

Chat service module 110 is a software module of server 100 and includes one or more programs for running a chat service. The chat service operated by chat service module 110 is accessible by chat application 170 and enables users to receive machine-generated natural-language text replies to user-generated text prompts. Chat service module 110 runs services used and/or invoked by chat application 170 and, further, provides user-generated prompts to language module 112 and provides natural-language text replies generated by the program(s) of language module 112 to user device 150. Natural-language text replies generated by server 100 and transmitted to user device 150 in this manner can communicated to a user via chat application 170. For example, chat application 170 can cause output device 160 to display an indication, such as a text representation, of the natural-language text reply to allow a user (e.g., user 200) to read the reply and, in some examples, formulate a subsequent prompt.

While the service operated by chat service module 110 is generally referred to as a “chat service” herein, in some examples, the service operated by chat service 110 does not represent or relate user prompts and machine-generated replies as a natural-language text conversation. For example, the chat service operated by chat service module 110 can be an API for accessing functionality of language generation module 112, such that chat application 170 functions as an interface, program, etc. for accessing calling functions of the API.

Language generation module 112 is another software module of server 100 and includes one or more programs for automated natural-language text generation. Language generation module includes language model 120 and system prompt 130. Language model 120 is a machine-learning language model trained to generate natural-language outputs (or tokenized representations thereof) from natural-language inputs (or tokenized representations thereof). In some examples, language model 120 can include one or more programs for converting natural-language inputs into numeric representations and for converting numeric representations of text information into natural-language text. For example, language generation module 112 can include a tokenization algorithm for generating tokens representative of text (e.g., encoding user inputs) and for generating natural-language text based on token information (e.g., decoding machine-generated tokens). Language model 120 can be, for example, a large language model and/or a transformer model.

In some examples, language generation module 112 can use a context injection approach to reduce hallucinations and/or fabrications in the outputs of language model 120. For example, language generation module 112 can perform retrieval augmented generation by retrieving database information and supplementing or otherwise modifying user prompts with some or all of the retrieved database information. The database(s) used by language generation module 112 can include, for example, a structured database, a semi-structured database, and/or a vector database, among other options.

System prompt 130 is natural-language text and/or a tokenized representation of natural-language text (i.e., one or more tokens representative of natural-language text) and provides an initial prompt that acts as instructions to language model 120 for generating natural-language responses to user-generated prompt text. System prompt 130 can be stored as, for example, a natural-language text string, an encoded text string (e.g., encoded as one or more tokens), or any other suitable format. System prompt 130 is generally referred to herein as a “system prompt,” but in other examples system prompt 130 can be referred to as a “pre-prompt” or “internal prompt.” Language generation module 112 includes one or more programs that provide system prompt 130 to language model 120 prior to providing user prompts. The process of providing system prompt 130 to language model 120 is generally referred to herein as “system prompting,” but in other examples can be referred to as “pre-prompting” or “internal prompting.” In some examples, server 100 can store a default or standard system prompt 130 that can be modified by user device 150 and/or server 100 to incorporate user preference information.

Preference reconciliation module 140 is a software module of server 100 that includes one or more programs for reconciling user and operator preferences prior to system prompt generation and/or modification by prompt modification module 146. Preference reconciliation module 140 receives user and operator preferences and generates a condensed, reconciled group of preferences according to preference rules defined by a rules engine. Preference reconciliation module 140 removes conflicts between and among user-defined preferences and operator-defined preferences. As used herein, preferences, whether defined by an operator or a user, “conflict” when those preferences overlap, are at least partially exclusive (e.g., are mutually-exclusive), or otherwise are incongruous such that inclusion of both conflicting preferences in system prompt 130 is likely to cause the outputs of language model 120 to be confusing, unclear, or otherwise degraded in quality. Notably, by degrading the quality of the outputs of language model 120, the inclusion of conflicting preferences in system prompt 130 can also degrade the quality of user experience for users of the language generation functions of server 100. Preference reconciliation module 140 can reconcile conflicts between user and operator preferences by removing conflicting preferences from the final group used for system prompt modification. Preference reconciliation module 140 is able to selectively include preferences in a set of reconciled preferences such that the set of reconciled preferences has fewer conflicts than the original set of user and operator preferences and, in some examples, no conflicts.

Treating overlapping preferences as conflicts can, in some examples, reduce token size associated with a system prompt based on a set of reconciled preferences and, further, can provide additional improvements to language outputs beyond merely excluding preferences that are exclusive. For example, operator and user preferences for two different brands that are related, but non-exclusive, may nonetheless degrade the outputs of language model 120 where language model 120 is not able to accurately determine, from the natural-language context of a system prompt 130 based on the set of reconciled preferences, the context(s) in which to refer to one preferred brand over the other. In these examples, the outputs of language model 120 can be confusing, ambivalent, or otherwise degraded in a manner that decreases the quality of user experience. Reconciling preferences using preference reconciliation module 140 can be used to provide a single preference in these examples, thereby avoiding providing language model 120 with an initial input (i.e., via system prompt 130) that is likely to degrade language generation performance. Further, as described previously, the exclusion of one or more overlapping, but non-exclusive, preferences can also advantageously reduce the token size of a system prompt 130 generated based on the set of reconciled preferences while still allowing the resultant system prompt 130 to include at least one preferences for a given category, topic, etc.

For example, an operator can define an extensive list of default preferences, some of which may overlap, be exclusive of, or otherwise conflict with user-defined preferences. As a specific example, if a user has a preference for a first service provider and has defined that preference using preference management application, and if an operator of server 100 has a preference for a second, competing service provider (i.e., due to a sponsorship or advertising contract with the second service provider), including references to both service providers in system prompt 130 can increase the likelihood that the second service provider is included in an output of language model 120 in addition to or in place of the user's self-defined preference for the first service provider. Including the second service provider in addition to or, less desirably, in place of the user-preferred competitor of the second service provider can increase user dissatisfaction with the language outputs offered by the chat service operated by server 100 and, consequently, negatively impact user retention.

In some examples, each user and operator preference can be assigned to a particular category, and preference reconciliation module 140 can reconcile preferences by selecting either one user preference or one operator preference belonging to each category. Preference reconciliation module 140 can use a software rules engine to decide whether to retain a user preference or operator preference for each category. In some examples, the identity of the preference (i.e., data describing the specific vendor, advertiser, membership program, etc. of the preference) and/or the origin of the preference (i.e., whether the preference is a user or operator preference) can be criteria used by the rules engine to reconcile conflicting preferences.

Additionally and/or alternatively, the preference reconciliation module 140 and the software rules engine can be configured to select multiple preferences for a single category. For example, certain user and operator preferences may not be exclusive, such that including both preferences in a system prompt generated by prompt modification module 146 will not adversely affect the quality of language generation performed by language model 120. The software rules engine can be configured to allow preference reconciliation module 140 to place two or more non-exclusive preferences belonging to a single category in the condensed, reconciled group used for system prompt modification.

In examples, where more than two preferences exist for a given category, preference reconciliation module 140 can optionally include any number of preferences in the set of reconciled preferences. For example, if three preference exist for a given category, preference reconciliation module 140 can include two preferences and/or all three preference for that category, according to the rules defined by the rules engine used by preference reconciliation module 140. Further, in examples where the user and/or operator of server 100 has defined conflicting preferences, preference reconciliation module 140 can also be configured to detect those conflicts and select a non-conflicting group of user and/or operator preferences according to, for example, the rules engine.

In at least some examples in which preferences are organized into preference categories, each user preference and operator preference can correspond to at least one preference category. In yet further examples, the user preferences received by preference reconciliation module 140 can have a one-to-one correspondence with the preference categories and/or the operator preferences can have a one-to-one correspondence with the preference categories, such that the number of preference categories is equal to the number of received user preferences and/or operator preferences, and at one operator preference and one user preference corresponds to each category.

Preference reconciliation module 140 and/or another suitable software element of server 100 can receive user preferences from preference management application 180 and/or from one or more of databases 182A-N as one or more natural-language words and/or as one or more encodings representative of natural-language words (e.g., one or more tokens). Preference reconciliation module and/or another suitable software element of server 100 can also receive operator preferences as natural-language text and/or encodings representative thereof that represent, describe, etc. operator preferences for language generation for the user from one or more of databases 182A-N. Operator preference(s) can be defined globally such that the same preferences apply for each user of the chat service operated by server 100 and/or server 100 can retrieve user-specific operator preferences.

User preferences used by preference reconciliation module 140 can include user membership information, user subscription information (e.g., to a subscription service), preferred vendor information, and/or advertisement preference information, among other options. Operator preferences stored by one or more of databases 182A-N can describe preferred vendor information and/or advertisement preference information, among other options. Operator preferences can be managed by preference reconciliation module 140, prompt modification module 146, and/or any other suitable program of server 100.

User and operator preferences can optionally be retrieved based on one or more user identifiers for the user, such as a username, account identifier, internet protocol address, and/or any other suitable credential or identifier. For example, server 100 can use a user identifier to query one or more of databases 182A-N to retrieve user preference information and/or operator preferences defined for that individual user. Advantageously, selecting operator preference information based at least in part on user identity can improve the likelihood that operator-preferred advertiser, vendor, or other suitable information is relevant to a particular user. The operator of server 100 can determine which vendor(s), advertiser(s), sponsor(s), etc. are likely to be relevant to a particular user and store that information to one or more of databases 182A-N. Server 100 can then retrieve user-specific operator preference information using user identifiers.

Generally, the preferences used by server 100 and reconciled by preference reconciliation module 140 describe user and operator preferences regarding the content of the outputs of language model 120, such as the inclusion of particular terms, references to particular entities, etc. In some examples, however, the preferences used by server 100 and reconciled by preference reconciliation module 140 can also describe preferred formatting of the outputs of language model 120, such as preferred response length, sentence length, paragraph structure, writing style, etc.

Notably, the set of reconciled preferences generated by preference reconciliation module 140 for a given user is user-specific (i.e., due to the incorporation of user-defined preferences into the preference pool used to generate the reconciled preferences) and can be stored to any suitable storage device and recalled for language generation requested by the user. For example, requests for language generation (i.e., requests for the functionality of language model 120) from chat application 170 can include a user identifier for the user. The user identifier can be used to retrieve a pre-generated set of reconciled preferences and/or a pre-generated system prompt based on a pre-generated set of reconciled preferences rather than generating a new but identical set of reconciled preferences using preference reconciliation module 140.

The software rules engine used by preference reconciliation module 140 can be any suitable software component for selecting user and operator preferences to be included in the set of reconciled preferences generated by preference reconciliation module 140. The software rules engine can be, for example, a priority list that defines priorities for including operator and user preferences in the set of reconciled preferences. The software rules engine can also be, for example, a software application or software-encoded list or rules configured to resolve conflicts between user and operator preferences and, in some examples, to differentially resolve user and operator preferences based on preference category, among other options. In at least some examples, the software rules engine can be a computer-implemented machine learning model trained or otherwise configured to generate or identify a set of reconciled preferences based on inputs defining or identifying user and operator preferences.

The software rules engine can be configured to prioritize and, further, to differentially prioritize user and operator preferences for inclusion in the reconciled set of preferences according to operator interests, preferences, goals, etc. For example, prioritizing user preferences over operator preferences can improve user experience by increasing the user-relevance of system prompt 130 and, consequently, the outputs of language model 120. As a further example, prioritizing operator preferences over user preferences can enable an operator to better fulfill commitments, goals, etc. related to the contents of the outputs of language model 120.

Prompt modification module 146 is a software module of server 100 that includes one or more programs for modifying system prompt 130 according to the reconciled preferences generated by preference reconciliation module. The program(s) of prompt modification module 146 can receive reconciled user-preferences from prompt preference reconciliation module 140 as one or more natural-language words and/or as one or more representations of natural-language words. The representations can be, for example, one or more encodings of natural-language words (e.g., one or more tokens). In examples where the encodings are not a format usable as inputs to language model 120, prompt modification module 146 can convert the received encodings into one or more natural-language words or into another encoding format usable by language model 120 (e.g., one or more tokens usable by language model 120). The program(s) of prompt modification module 146 can then modify system prompt 130 according to the received reconciled preference(s) by, for example, replacing all or part of a pre-existing or default system prompt with natural language or encodings representative of the received reconciled preference(s). In further examples, the program(s) of prompt modification module 146 can then modify system prompt 130 by adding the natural-language words and/or encodings of the reconciled preferences to the natural-language words and/or encodings of a pre-existing, default, or other preferred system prompt.

Chat application 170 is a software application of user device 150 for receiving user prompts, providing those prompts to server 100, receiving responses from server 100, and communicating those responses to the user (e.g., user 200). Chat application 170 can be, in some examples, a web browser for accessing a web application hosted by server 100 that uses the functionality of chat service module 110. Additionally and/or alternatively, chat application 170 can be a specialized software application for interacting with chat service module 110 of server 100. Chat application 170 can be selectively operated by user device 150. For example, a user can provide one or more inputs to user device 150 to cause user device 150 to begin operating chat application 170. A user can provide user prompts by, for example, typing a natural-language phrase or sentence using a keyboard or a similar input device.

In some examples, chat application 170 can include a graphical user interface including one or more selectable graphical elements, such as one or more clickable elements and/or graphical buttons, representative of a natural-language text phrases that can be used as prompts for language model 120. A user can provide prompts to chat application 170 by interacting with the graphical elements of chat application 170 to select the natural-language text phrase(s) the user wants to use as an input to or prompt for language generation. Chat application 170 can then transmit the selected natural-language text phrase(s) to server 100 as the prompt for language generation by language model 120.

In some examples, chat application 170 can include a graphical user interface that displays a chat history between the user and server 100, such that a user can view previous user-submitted prompts and machine-generated replies created by server 100. Chat application 170 can display prior text replies as, for example, a conversation history or in any other suitable format. In some examples, chat 170 can also display only the most-recent language generated by server 100.

Preference management application 180 is a software application of user device 150 for managing user preferences and for creating system prompt or pre-prompt information that can be used to modify system prompt 130 to incorporate user preferences. Preference management application 180 manages and stores (e.g., to memory 154, memory 104, etc.) user preferences for use in system prompt 130. Preference management application 180 can store user preferences as, for example, one or more text strings and/or as a text representation (e.g., an encoding) that can be provided to server 100 for preference reconciliation by preference reconciliation module 140. In these examples, user device 150 can optionally include an encoding algorithm (e.g., a tokenizing algorithm) suitable for generating encoded text usable by language model 120 (i.e., of the type of encoded text on which language model 120 was trained). In at least some examples, preference management application 180 is a software plugin or extension for a web browser. Preference management application 180 can store user preferences (e.g., to memory 104, memory 154, etc.) such that user preference information can be retrieved after a period in which the language generation functions of server 100 are inactive, allowing user preferences to be defined ahead of language generation and to be retrieved when program(s) of language generation module 112 are executed to generate natural language using language model 120.

A user can interact with software elements of preference management application 180 to define preferences in the outputs of language generation. Preference management application 180 can store those user preferences to user system 150 and/or server 100 for use by preference reconciliation module 140. In some examples, preference management application 180 can store user preferences to a database and/or another suitable device connected to network 188. In yet further applications, preference management application 180 can provide user preferences to server 100 and server 100 can store those preferences to one or more of databases 182A-N. Server 100 can retrieve user preferences for system prompt modification by, for example, querying the relevant database(s) with a user identifier for a user submitting a natural-language prompt.

Preference management application 180 can generate a user-specific natural-language text phrase (or an encoding representative thereof) based on the preference information provided by the user and can provide that natural-language text phrase (or encoding representative thereof) to server 100. As a further example, preference management application 180 can transmit preference information to server 100 and server 100 can generate a user-specific natural-language text phrase based on the preference information.

Preference management application 180 can be configured to solicit (i.e., from a user) and store (e.g., to memory 154) any suitable information describing user preferences for the outputs of language model 120. For example, the user preference(s) managed by preference management application 180 can include user membership information, user subscription information (e.g., to a subscription service), preferred vendor information, and/or advertisement preference information, among other options. In some examples, the user preference(s) managed by preference management application can also include suitable data sources by context injection (e.g., retrieval augmented generation) by language generation module 112.

Graphical user interface 190 is an optional element of user device 150 and is graphical user interface for defining user preferences and is operated by the program(s) of preference management application 180. Graphical user interface 190 can be displayed by, for example, user interface 156 (e.g., output device 160) of user device 150. Graphical user interface 190 includes graphical objects 192A-N that a user can use to interact with preference management application 180 and to define user preferences. A user can control pointer 194 via, for example, input device 158 to interact with graphical objects 192A-N to define user preferences. Graphical objects 192A-N can be, for example, one or more checkboxes or radio buttons that a user can select to define user preferences for preference management application 180. In other examples, a user can input one or more text strings defining user preferences. Preference management application 180 can store the text string as user preference information for the user and/or can extract relevant text from the text string and store the extracted text as user preference information for the user. For example, preference management application 180 can extract one or more keywords and/or can use a natural language processing algorithm to identify and extract relevant information from the text string (e.g., intent and/or entity information).

In some examples, server 100 can also operate a graphical user interface that an operator of server 100 can use to define operator preferences. Server 100 can then store operator preference information to memory 104 and/or one or more databases (e.g., one of databases 182A-N), and can retrieve operator preference information subsequently to generate a set of reconciled preferences for a user (e.g., using preference reconciliation module 140). The graphical user interface can be any suitable graphical user interface and in some examples can be substantially similar to graphical user interface 190.

In operation, server 100 receives user preference information and operator preference information and reconciles the user and operator preference information using preference reconciliation module 140. Server 100 can receive user preference and operator preference information in several ways. Preference management application 180 can automatically transmit preference information when the user transmits a natural-language prompt via chat application 170. Additionally and/or alternatively, server 100 can retrieve user preference information (e.g., as natural-language text, one or more encodings, etc.) and/or operator preference information (e.g., as natural-language text, one or more encodings, etc.) when server 100 receives a user prompt. In some examples, server 100 can also retrieve user preference and/or operator preference information when server 100 server 100 authenticates user access to language generation module 112 (e.g., based on user account credentials).

Server 100 modifies system prompt 130 using prompt modification module 146 according to the set of reconciled preferences generated by preference reconciliation module 140. The modified system prompt 130 is provided to language model 120 as an initial input ahead of user prompts submitted by a user via chat application 170. User prompts received from user device 150 are used as subsequent inputs to language model 120 and the resulting outputs of language model 120 are provided (i.e., via chat service module 110) to user device 150 and communicated to the user.

Advantageously, system 10 enables user and operator preference information to be reconciled into a condensed set of preferences representative of both user and operator preference information. The condensed, reconciled set of preferences generated by preference reconciliation module 140 to dynamically modify system prompt 130 of server 100 to improve the quality and user-relevance of language generated by language model 120. Notably, improving the user-relevance of the outputs of language model 120 can significantly improve user experience when using the chat service operated by chat service module 110 and/or the language generation functions of language model 120. For example, if a user prompt inquires for recommendations for a particular type of product and if the user preferences stored by preference management application 180 define a range of preferred vendors (i.e., preferred by the user) for that type of product, providing a user-specific system prompt defining those vender preferences can decrease the likelihood that an output of language model 120 includes a recommendation for a non-preferred vendor, thereby improving user satisfaction with the output of language model 120.

Server 100 and, in particular, preference reconciliation module 140 are able to reconcile operator and user preferences that are conflicting (e.g., overlapping, mutually-exclusive, etc.) into a single, condensed set of reconciled preferences that can be used by prompt modification module to modify system prompt 130. Advantageously, the reconciliation function of server 100 (as facilitated by preference reconciliation module 140) enables operator and user preference information to be used to generate a custom system prompt 130 while avoiding disadvantages to language generation that can be caused by conflicting (e.g., overlapping, mutually-exclusive, etc.) preference information in system prompt 130. As described previously, preference conflicts in system prompt 130 can degrade the quality of language outputs from language model 120. Conflicts in system prompt 130 can, for example, cause the outputs of language model 120 to fail to accurately generate language responsive to one or all of the conflicting preferences, thereby increasing the likelihood that language generated by language model 120 fails to address user interests and/or fails to advance operator interests, needs, preferences, goals, etc. Further, system 100 is able to reconcile user and operator preference information in an automated and/or automatic manner, and therefore does not require manual intervention by a human operator to reconcile user and operator preference information.

FIG. 1 depicts only one user device (i.e., user device 150) for illustrative convenience and for clarity, but in other examples, system 10 can include any number of user devices. System 10 can, for example, include multiple analogous user devices serving parallel functions, e.g., at different locations and/or for different users. Additionally or alternatively, functions of user device 150 (and any analogous user devices) can be distributed across multiple separate hardware devices accessible locally and/or via network 188. Similarly, while server 100 is depicted as a single device in FIG. 1, in other examples, server 100 can include multiple devices (e.g., multiple servers) configured to perform the functions of server 100.

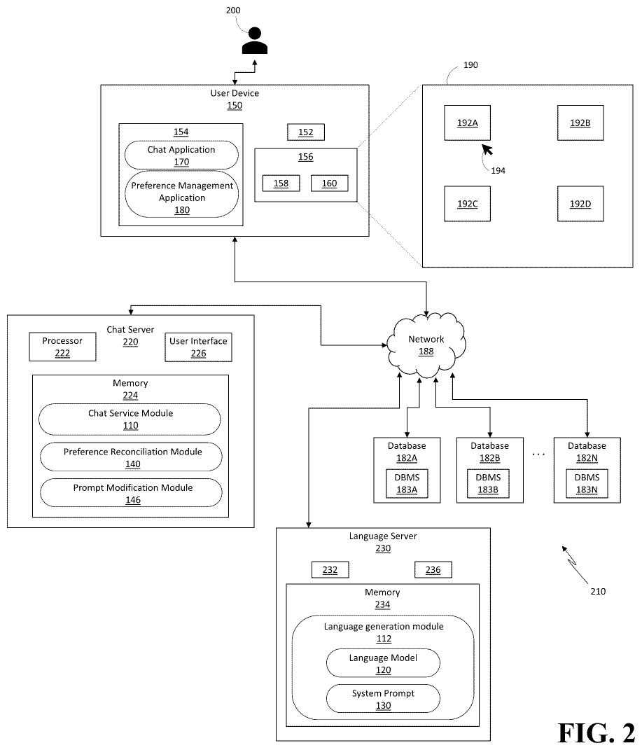

FIG. 2 is a schematic depiction of system 210, which is another example of a system for generating natural-language responses to user-generated prompts. System 210 is substantially similar to system 10, but also includes chat server 220 and language server 230 instead of server 100. Chat server 220 includes processor 222, memory 224, and user interface 226, which are substantially similar to processor 102, memory 104, and user interface 106, respectively, and the discussion herein of processor 102, memory 104, and user interface 106 is applicable to processor 222, memory 224, and user interface 226, respectively. Language server 230 includes processor 232, memory 234, and user interface 236, which are substantially similar to processor 102, memory 104, and user interface 106, respectively, and the discussion herein of processor 102, memory 104, and user interface 106 is applicable to processor 232, memory 234, and user interface 236, respectively. In system 210, memory 224 stores chat service module 110, preference reconciliation module 140, and prompt modification module 146, and memory 234 stores language generation module 112.

In system 210, chat server 220 includes chat service module 110, preference reconciliation module 140, and prompt modification module 146 and chat server 220 operates the chat service accessed by chat application 170 and modifies system prompt 130 (or causes language server 230 to modify system prompt 130) according to the reconciled user and operator preferences generated by preference reconciliation module 140. Language server 230 includes language generation module 112 and performs language generation to create natural-language responses for chat server 220. Chat server 220 is configured to access the language generation functionality of language server 230 and can send one or more commands to language server 230 (e.g., one or more API calls) to cause language server 230 to generate natural-language responses to user prompts. Chat server 220 can also issue one or more commands to language server 230 to modify system prompt 130. Each of chat server 220 and language server 230 can operate an API exposed to allow other devices (e.g., user device 150 and chat server 220, respectively) to access the functionality of chat server 220 and/or language server 230.

In operation of system 210, user device 150 sends user preferences and user-generated natural-language prompts to chat server 220. Chat server 220 retrieves operator preferences from, e.g., one or more of databases 182A-N. Chat server 220 generates a set of reconciled preferences based on the received user and operator preferences using preference reconciliation module 140. Chat server 220 then accesses functionality of language server 230 to modify system prompt 130 based on the reconciled set of preferences and further to generate a natural-language response to user-submitted prompts or queries. Chat server 220 then provides the generated natural-language response to user device 150.

System 210 confers several advantages. System 210 confers the advantages of system 10 discussed previously. Further, system 210 is able to confer the advantages of system 10 in situations where it is advantageous for chat server 220 and language server 230 to be separate devices and, further, in examples where those separate devices are separated by large geographic distances. As a specific example, system 210 enables the advantages of system 10 where the entity operating the chat service (i.e., operating chat server 220) is a different entity than the entity operating language server 230. Chat server 220 can receive preferences form preference management application 180 and use those preferences to modify the system prompt of a third-party language server 230 to perform user-specific language generation according to the present disclosure.

FIG. 2 depicts only one user device (i.e., user device 150) for illustrative convenience and for clarity, but in other examples, system 210 can include any number of user devices. Similarly, while chat server 220 and language server 230 are each depicted as a single device in FIG. 2, in other examples, each of chat server 220 and language server 230 can include multiple devices (e.g., multiple servers) configured to perform the functions of server 100. Further, while chat server is depicted as including preference reconciliation module 140 and prompt modification module 146, in other examples, language server 230 can include one or both of preference reconciliation module 140 and prompt modification module 146.

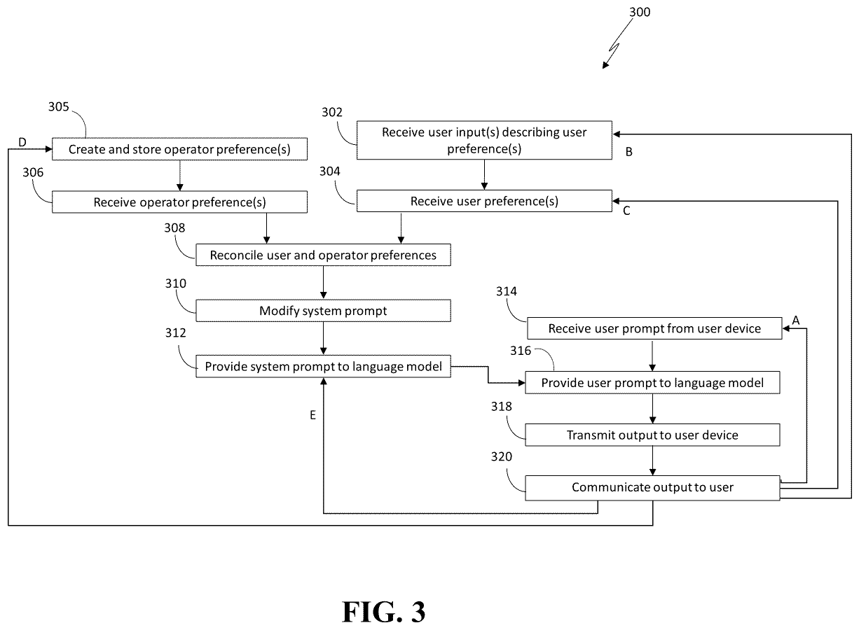

FIG. 3 is a flow diagram of method 300, which is a method of generating and using user-specific system prompts suitable for use with systems 10, 210 (FIGS. 1-2). Method 300 includes steps 302-326 of receiving a user input(s) describing a user preference(s) (step 302), receiving user preference(s) (step 304), creating and storing operator preference(s) (step 305), receiving operator preference(s) (step 306), reconciling user and operator preferences (step 308) modifying a system prompt (step 310), providing the system prompt to a language model (step 312), receiving a user prompt from the user device (step 314), providing the user prompt to the language model (step 316), transmitting the natural-language response to the user device (step 318), and communicating the output to the user (step 320). Method 300 is generally described herein with respect to the devices of system 10 (and the same, functionally equivalent, and/or similar devices of systems 210), but method 300 can be performed using any suitable system to confer advantages related to user-specific system prompts. FIG. 3 also includes arrows A-E, which represent different iteration options for method 300.

In step 302, server 100 receives a user input describing a user preference. The input can be submitted via one or more input devices (e.g., input device 158) and/or user interface devices (e.g., user interface 156) of a user device and can be used by preference management application 180 to define user preferences in subsequent steps of method 300. The input(s) can be any suitable input(s) and, in some examples, can target one or more graphical objects (e.g., of graphical objects 192A-N) of a graphical user interface (e.g., graphical user interface 190). The graphical objects can be, for example, one or more checkboxes that are selectable by the user (e.g., by using a pointer or cursor controlled by an input device). The graphical objects can also be, for example, one or more selectable icons depicting natural language representations of preference information. The input device can be, for example, a mouse, a keyboard, and/or a touchscreen, among other options. In some examples, the input can be a user-provided a natural-language text string detailing and/or describing the user's preferences. Any number of inputs can be received in step 302 defining any number of user preferences. Additionally and/or alternatively, a user can select, indicate, describe, etc. user preference information in natural language provided to user device 150 (e.g., via a user interface device, such as a keyboard or touchscreen).

The user preference can be stored to the user device, to server 100, and/or one or more of databases 182A-N (or another suitable storage device connected to network 188) for further use with method 300 and/or with additional iterations of method 300. User preference information can also be optionally stored temporarily to a memory of the user device and then subsequently transmitted to server 100 to be stored for use with further steps of method 300. The user preference can be stored by, for example, storing the data representative of the user preference to a memory of the user device (e.g., memory 104, memory 154, one or more of databases 182A-N, etc.). The user preference can be stored as a natural-language representation of the user preference. Additionally and/or alternatively, the user preference can be pre-encoded for use by a language model in subsequent steps of method 300 and the encoded form of the user preference can be stored in step 302. The user preference can be encoded as, for example, one or more tokens representative of the user preference. Any number of user preferences can be stored according to the number of user preferences defined in step 302. In some examples, the user preference information can be organized and/or arranged in a format suitable as a system prompt for a natural-language model, and can be stored in that format and/or as an encoding representative thereof.

Step 302 is optional and is performed in examples of method 300 where it is advantageous for a user to define the user's preferences. In some examples and particularly where user preferences are unknown, it may be suitable for a user to define the user's preferences. In other examples, such as where the user's preferences are known and/or where another entity (e.g., an entity operating the server that runs a chat service and/or language generation) knows of or prefers to define user preferences, step 302 can be omitted and user preferences can be defined by the non-user entity, and method 300 can begin from step 304.

In step 304, server 100 receives user preference information. Server 100 can receive user preference information from, for example, from the user device (e.g., user device 150), by recalling user preference information from memory 104 of server 100, and/or by retrieving user preference information from one or more of databases 182A-N. Server 100 can receive user preference information by recalling user preference information from memory 104 in examples where server 100 stores user preference information previously provided to a user device and transmitted to server 100. In these examples, method 300 can optionally omit step 302 and can begin from step 304. Server 100 receives user preference information as natural-language text (including as an electronic indication thereof) and/or as an encoding representative of the natural-language text (including as an electronic indication thereof). The preferences can, in some examples, be received as a pre-generated system prompt descriptive of and/or reflective of user preference information. In some examples, additional user preference information received outside of step 302 (e.g., provider-supplied user preferences) can be received in addition to or alternatively to the user preferences received in step 302. Advantageously, receiving user preference(s) as encodings (e.g., tokens) in step 304 can reduce computational load on server 100 associated with encoding (e.g., tokenizing) natural-language information representative of the user preference(s).

User device 150 and/or server 100 can, for example, generate natural language representative of user preference information based on inputs from a user to a graphical user interface operated by user device 150 (e.g., graphical user interface 190). User device and/or server 100 can be configured to automatedly and/or automatically generate natural-language and/or an encoding representative thereof that corresponds to the preferences indicated by the user in the graphical user interface. User device 150 and/or server 100 can be configured to remove filler words from the user-provided natural language using, for example, one or more natural language processing models configured to identify and/or remove filler language and/or a machine-learning language model to generate a natural-language summary of the user-provided natural language.

Step 304 can be performed by server 100, user device 150, and/or a combination thereof. Server 100 can, for example, retrieve user preference information in step 304 from the user device when server 100 receives the user prompt in subsequent step 314. Server 100 can send one or more requests to user device 150 in response to receiving a user prompt and can receive user preference information from user device 150 in response to the request(s). In examples where the user device authenticates user access to language model 120 prior to generating a natural-language output based on a user prompt (e.g., during or subsequent to a user log-on), server 100 can also request user preference information from the user device during access authentication. One or more programs of server 100 can then modify system prompt 130 based on the provided user preference(s) in step 308. Additionally and/or alternatively, user device 150 can be configured to automatically provide user preference information to server 100 in step 304. User device 150 can be configured to, for example, automatically transmit user device information to server 100 (e.g., via network 188) when a user prompt is transmitted to server 100 and/or when user device 150 is operating chat application 170.

In step 305, operator preference(s) are created and stored. Operator preference information can be defined by the operator of the chat service of chat service module 110 and stored to one or more of databases 182A-N. An operator can manually define operator preference data (e.g., by creating data defining operator preferences on server 100, a database 182A-N, etc.) and/or can use a software application of server 100 and/or another suitable device connected to server 100 or network to define operator preference(s). In some examples, an operator of server 100 can define operator preferences on a user-by-user or group-by-group basis, allowing the operator to differentially define operator preferences for specific individual users and/or specific groups of individual users. Operator preference(s) can be stored as natural-language text, as one or more encodings representative of operator preference(s), and/or as another suitable type of data representative of natural-language text describing operator preference(s).

In step 306, server 100 receives operator preference information. Server 100 can retrieve operator preference information from the location (i.e., device, system, etc.) to which operator preference is stored. For example, if operator preference information is stored to memory 104, server 100 can receive operator preference information by recalling the operator preference information from memory 104. As an additional example, if operator preference information is stored to one or more of databases 182A-N, server 100 can query the relevant database(s) 182A-N to receive operator preference information. In some examples, operator preference information can be received from a database (e.g., one or more of databases 182A-N) by querying the database with a user identifier for the user for which user preferences were received in step 304 (i.e., the user that submitted the prompt in step 314, discussed subsequently).

In step 308, the user preferences received in step 304 are reconciled with the operator preferences received in step 306. In step 308, server 100 identifies incongruities between and/or among user and operator preferences and resolves those incongruities to generate a set of reconciled preferences that includes at least some of the user and operator preferences received in steps 304 and 306. The reconciled set of preferences generated in step 308 includes fewer than all operator and user preferences, such that at least some user and operator preferences are excluded from a set of reconciled preferences. The preference reconciliation performed in step 308 excludes user and operator that are determined to conflict or otherwise are likely to degrade the quality of the outputs of language model 120 (as discussed previously) if included together in the set of reconciled preferences.

The user and operator preferences are reconciled by server 100 using a rules engine, as described previously in the description of preference reconciliation module 140 (FIG. 1). The rules engine can be, for example, a priority list for resolving conflicts or differences between user and operator preferences. The software rules engine can also be, for example, a software application or software-encoded list or rules configured to resolve conflicts between user and operator preferences and, in some examples, to differentially resolve user and operator preferences based on preference category.

The software rules engine can, in yet further examples, be one or more computer-implemented machine-learning models trained or otherwise configured to generate or identify a set of reconciled preferences based on inputs defining or identifying user and operator preferences. In some examples, preference reconciliation module 140 can use a first trained machine-learning model configured to determine whether pairs or sets of preferences conflict, and a second trained machine-learning model to determine which preference(s), of two or more conflicting preferences, should be included in a reconciled preference set. In other examples, preference reconciliation module 140 can use a single trained machine learning model configured to accept a set of operator and/or user preferences and to output an indication of which preferences should be included in a set of reconciled preferences.

In some examples, each user and operator preference received in steps 304 and 306, respectively, can be assigned to a particular category, and preference reconciliation module 140 can reconcile preferences by, for example, selecting either one user preference or one operator preference belonging to each category. Preference reconciliation module 140 can identify conflicts between user and operator preferences for a given preference category and use a software rules engine to decide whether to retain a user preference or operator preference for each category. Identifying a conflict between user and operator preferences can include, for example, applying the rules engine or another suitable software module to determine whether two or more user and or operator preferences belonging to a single preference category conflict. In some examples, server 100 can be configured to recognize the mere presence of two or more preferences belonging to the same category as a conflict. In yet further examples, server 100 can be configured to use the identity of preferences belonging to a shared preference category to identity a conflict. Upon identifying conflicting user and/or operator preferences, server 100 can use the software rules engine to identify which of the conflicting preferences should be included in the set of reconciled preferences and/or which of the conflicting preferences should be excluded from the set of reconciled preferences.

In some examples, the identity of the preference (i.e., data describing the specific vendor, advertiser, membership program, etc. of the preference) and/or the origin of the preference (i.e., whether the preference is a user or operator preference) can be criteria used by the rules engine to reconcile conflicting preferences. In some examples, the rules engine can also populate the set of reconciled preferences with more than one preference per preference category (e.g., more than one user/operator preference, one user preference and one operator preference, etc.) where those preferences do not conflict and/or are not likely to degrade the quality of language generation when included together in system prompt 130. Preference category information can be stored with user and operator preferences, such that preference category information is received in steps 304, 306. Additionally and/or alternatively, server 100 can be encoded with a table, chart, etc. that can be used to determine the preference category to which user and/or operator preferences belong.

The set of reconciled preferences generated in step 308 can be stored to memory 104 and/or one or more of databases 182A-N for further use with method 300. The set of reconciled preferences can be stored as, for example, one or more natural-language words and/or encodings thereof (e.g., tokens). In some examples, step 308 can occur a period of time before other steps of method 300 and the set of reconciled preferences generated in step 308 can be recalled or otherwise retrieved (i.e., from memory 104 and/or one or more of databases 182A-N) prior to step 310 of method 300.

In step 310, server 100 modifies system prompt 130 provided to language model 120 prior to language generation based on the set of reconciled preferences generated in step 308. System prompt 130 can be modified by, for example, augmenting a pre-existing system prompt (e.g., a default system prompt) with the reconciled preference information received in step 308. Additionally and/or alternatively, the system prompt can be modified by replacing some or all of the pre-existing system prompt (e.g., a default system prompt) with new system prompt information based on the reconciled preference information received in step 308.

In step 312, the system prompt modified in step 310 (e.g., system prompt 130) is provided to language model 120. The system prompt can be provided as an initial set of instructions and/or as an initial prompt to language model 120. In at least some examples, language model 120 does not generate natural language in response to the system prompt provided in step 310. In other examples, language model 120 can generate natural language responsive to the system prompt, but that natural language is not provided to the user via chat application 170.

In step 314, server 100 receives a user prompt from the user device, such as user device 150. The prompt is natural-language text (e.g., a text string) that includes a natural-language representation of one or more user questions and/or statements for prompting natural-language generation by language model 120. A user can enter a message composed at least partially of the question(s) and/or statement(s) into a chat application configured to interact with and use functionality of server 100 (e.g., chat application 170), and the chat application can provide the message to server 100. The received message can be used as the prompt received in step 314. In some examples, server 100 can remove portions of the user message, such as extraneous filler words, and use the resulting natural-language text as the prompt.

In step 316, the user prompt received in step 314 is provided as an input to language model 120. The user prompt can be provided as natural language and/or as an encoding representative thereof. In examples where the user prompt is provided as an encoding representative of natural language (e.g., as one or more tokens), server 100 and/or user device 150 can generate the encoding based on the natural language of the user prompt. Language model 120 generates a natural-language output and/or an encoding representative thereof based on the user prompt. The natural-language output can be stored to, for example, memory 104 and used with further steps of method 300. In some examples, server 100 can query one or more databases (e.g., one or more databases 182A-N) based on the user prompt, the user's preference(s), and/or the operator's preference(s) as part of a context-injection approach to language generation (e.g., retrieval-augmented generation). Steps 312 and 314 can be performed in any order, but both steps 312 and 314 are performed prior to step 316.

In step 318, the output generated in step 316 is transmitted from server 100 to user device 150. The output can be transmitted as, for example, one or more packets via network 188. Server 100 can be configured to automatically transmit the output to user device 150 after step 316.

In step 320, user device 150 communicates the output generated in step 318 to the user operating the user device. User device 150 can provide an indication of the output to the user, such as displayed text of the natural-language output, spoken audio of the natural-language output, etc.

After step 320, method 300 can proceed via any of arrows A-E to steps 302, 304, 305, 312, and 314. Method 300 can proceed to step 314 (i.e., via arrow A) where user and/or operator preference information does not need to be updated prior to further natural-language generation for that user, such that the previously-generated set of reconciled preferences can be used for further language generation. Method 300 can proceed to step 302 (i.e., via arrow B) in examples where a user modifies the user's preference information stored by preference management application 180 after reviewing an output from language model 120 communicated in step 320. Method 300 can proceed to step 304 (e.g., via arrow C) in examples where the user preference information is no longer stored by server 100 (e.g., due to a server restart, etc.) and/or the language model, system, and/or server performing language generation is changed following an iteration of step 320. For example, one iteration of steps 310-318 can be performed using a first language model by providing user preferences and modifying a system prompt stored by the system and/or server operating the first language model, and an additional iteration of step 310-318 can be performed using a second language model by again providing user preferences and modifying the system prompt used by the system and/or server operating the second language model. In these examples, step 306 can optionally be performed again to provide server 100 with an additional copy of operator preferences. Method 300 can proceed to step 305 (e.g., via arrow D) in examples where an operator modifies or desires to modify operator preference information. In at least some examples, method 300 can proceed to both steps 302 and 305 following step 320 (i.e., via both arrows B and D) to generate a new natural-language output based on updated user preferences and updated operator preferences. Method 300 can proceed to step 312 (e.g., via arrow E) in examples where the user-specific system prompt will no longer be included in a language model's context window used during language generation. In these examples, method 300 can proceed to step 310 to provide another copy of the system prompt to the language model prior to providing the new user prompt to the language model in step 314. Examples of method 300 that iterate according to arrow E can also include an additional iteration of step 312 (e.g., via arrow A).

Method 300 provides several advantages. Method 300 provides a method of user-specific natural-language generation by a language model (e.g., a large language model and/or transformer model) based on a system prompt that incorporates both user and operator preferences. In particular, method 300 generates a system prompt based on a single, condensed set of reconciled preferences and does not include operator and/or user preferences that are conflicting (e.g., overlapping, mutually-exclusive, etc.). The preference reconciliation performed by method 300 allows operator and user preference information to be used to generate a custom system prompt for language generation while avoiding disadvantages that can be caused by the presence of conflicting preferences (e.g., overlapping, mutually-exclusive, etc.) in a system prompt. Advantageously, including both user and operator preference information in the system prompt provided in step 312 increases the likelihood that language generation in step 316 is relevant to user interests and also advances operator interests, needs, preferences, goals, etc. The preference reconciliation aspect of method 300 can be performed in an automated and/or automatic manner, reducing the need for human input to manually reconcile operator and user preferences.

FIG. 5 is a flow diagram of method 500, which is a method of training a machine-learning algorithm according to the present disclosure for performing preference reconciliation as part of preference reconciliation module 140 (FIG. 1) and/or during step 308 of method 300 (FIG. 3). Machine-learning algorithms trained according to method 500 are capable of accepting as inputs natural-language text and/or representations thereof describing user and/or operator preferences for language generation and outputting a determination as to whether those preferences conflict and/or a determination as to which preference(s) should be included in a final set of reconciled preferences. Trained machine-learning models generated according to method 500 can be trained to generate a complete set of reconciled preferences based on a set of input user and operator preferences, to identify conflicting preferences, and/o to resolve conflicts between conflicting preferences, among other options. Method 500 includes steps of 502-506 of generating labeled training data (step 502), training a computer-implemented machine learning model with the labeled data (step 504), and testing the trained computer-implemented machine learning model with test data (step 506).

In step 502, labeled training data is generated. The labeled data can be, for example, preference information labeled to describe whether those preferences conflict or sets of two or more operator and user preferences labeled to indicate whether those preferences should be included among a set of reconciled preferences, among other options.

In step 504, the labeled data is used to train the computer-implemented machine learning model. As used herein, “training” a computer-implemented machine learning model refers to any process by which parameters, hyper parameters, biases, weights, and/or any other value related to model accuracy are adjusted to improve the fit of the computer-implemented machine learning model to the training data. Training in step 504 can be performed iteratively to improve the fit of the computer-implemented machine learning model until the fit of the machine-learning model to the training data is acceptable.

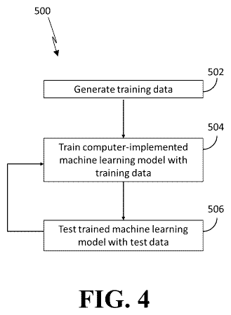

In step 506, the trained computer-implemented machine learning model is tested with test data. The test data used in step 506 is unlabeled data of the same variety as the training data that is used to qualify and/or quantify performance of the trained computer-implemented machine learning model. More specifically, a human or machine operator can evaluate the performance of the machine learning model by evaluating the fit of the model to the test data. As depicted in FIG. 4, steps 504 and 506 can be performed iteratively to improve the performance of the machine learning model. More specifically, if the fit of the model to the unlabeled data determined in step 506 is undesirable, step 504 can be repeated to further adjust the parameters, hyper parameters, biases, weights, etc. of the model to improve the fit of the model. Step 506 can then be repeated with a new set of unlabeled test data to determine how the adjusted model fits the new set of unlabeled test data. If the fit continues to be undesirable, further iterations of steps 504 and 506 can be performed until the fit of the model becomes desirable.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A method of language generation, the method comprising:
receiving, by a server and from a user device, a plurality of user preferences for natural-language outputs generated by a machine-learning language model based on user-provided natural-language text inputs, the plurality of user preferences provided by a user of the user device;
receiving, by a server and from the user device, a natural-language text prompt provided by the user to a chat application operating on the user device;
receiving a plurality of operator preferences for the natural-language outputs, the plurality of operator preferences determined by an operator of the server;
generating, by the server, set of reconciled preferences according to a rules engine, the set of reconciled preferences including fewer than all of the plurality of operator preferences and the plurality of user preferences;
modifying, by the server, a system prompt for the machine-learning language model based on the set of reconciled preferences to generate a modified system prompt;
providing, by the server, the modified system prompt as an initial input to the machine-learning language model;
providing, by the server and after providing the modified system prompt, the natural-language text prompt as an input to the machine-learning language model to generate a natural-language text output;
transmitting, by the server, the natural-language text output to the user device; and
communicating, by the chat application and via the user device, the natural-language text output to the user.

2. The method of claim 1, wherein:
the plurality of user preferences corresponds to a plurality of preference categories; and
at least one operator preference of the plurality of operator preferences corresponds to at least one preference category of the plurality of preference categories.

3. The method of claim 2, wherein generating the set of reconciled preferences comprises selecting, for at least one preference category of the plurality of preference categories, one user preference of the plurality of user preferences or one operator preference of the plurality of operator preferences.

4. The method of claim 3, wherein generating the set of reconciled preferences comprises selecting, for at least another preference category of the plurality of preference categories, one user preference of the plurality of user preferences and one operator preference of the plurality of operator preferences.

5. The method of claim 3, wherein generating the set of reconciled preferences comprises selecting, for each preference category of the plurality of preference categories, one user preference of the plurality of user preferences or one operator preference of the plurality of operator preferences.

6. The method of claim 5, wherein the plurality of preference categories comprises at least one of a membership category, a subscription category, a user-preferred vendor category, an advertisement preference category, and a data source category.

7. The method of claim 6, wherein the plurality of operator preferences comprises at least one of a membership, a subscription, a user-preferred vendor, a user advertisement preference, and a user-preferred data source for context injection.

8. The method of claim 7, wherein the plurality of user preferences comprises at least one of an operator advertisement preference, an operator-preferred vendor, and an operator-preferred data source for context injection.

9. The method of claim 2, wherein generating the set of reconciled preferences comprises:
identifying, by the server, that an operator preference of the plurality of operator preferences and a user preference of the plurality of user preferences belong to a single preference category of the plurality of preference categories; and
selecting, in response to the identification and using the rules engine, one of the operator preference and the user preference to include in the set of reconciled preferences.

10. The method of claim 2, wherein the plurality of operator preferences corresponds to the plurality of preference categories.

11. The method of claim 10, wherein the plurality of user preferences has a one-to-one correspondence with the plurality of preference categories.

12. The method of claim 11, wherein the plurality of operator preferences has a one-to-one correspondence with the plurality of preference categories.

13. The method of claim 12, wherein receiving the plurality of user preferences comprises querying, by the server, a first database with a user identifier for the user to retrieve the plurality of user preferences.

14. The method of claim 13, wherein receiving the plurality of operator preferences comprises querying, by the server, a second database to retrieve the plurality of operator preferences.

15. The method of claim 14, wherein querying the second database comprises querying the second database with the user identifier.

16. The method of claim 15, wherein receiving the plurality of user preferences comprises, before querying the first database:
receiving, by a user interface of the user device, at least one input describing the plurality of user preferences;
storing an indication of the plurality of user preferences to at least one memory of the user device; and
transmitting the indication to the first database to store the plurality of user preferences to the first database.

17. A system for language generation, the system comprising:
a user device comprising:
a first processor; and
at least one first memory storing a plurality of user preferences for natural-language outputs generated by a machine-learning language model based on user-provided natural-language text inputs, the plurality of user preferences determined by a user of the user device, wherein the at least one first memory is encoded with first instructions that, when executed cause the first processor to:
provide the natural-language text string as a natural-language text prompt to a chat application operating on the user device, and
receive a natural-language text prompt; and
a remote device communicatively connected to the user device, the remote device comprising:
a second processor; and
at least one second memory encoded with second instructions that, when executed, cause the second processor to:
receive the natural language text prompt from the user device;
receive the plurality of user preferences from the user device;
receive a plurality of operator preferences for the natural-language outputs, the plurality of operator preferences determined by an operator of the server;
generate a set of reconciled preferences by according to a rules engine, the set of reconciled preferences including fewer than all of the plurality of operator preferences and the plurality of user preferences;
modify a system prompt for the machine-learning language model based on the set of reconciled preferences to generate a modified system prompt;
provide the modified system prompt as an initial input to the machine-learning language model;
provide, after modifying the system prompt, the natural-language text prompt as a subsequent input to the machine-learning language model to generate a natural-language text output; and
transmit the natural-language text output to the user device.

18. The system of claim 17, wherein the first instructions, when executed, cause the first processor to cause the chat application to communicate the natural-language text output to the user.

19. The system of claim 18, wherein:
the plurality of user preferences corresponds to a plurality of preference categories, and
at least one operator preference of the plurality of operator preferences corresponds to at least one preference category of the plurality of preference categories.

20. The system of claim 19, wherein the second instructions, when executed, cause the second processor to generate the set of reconciled preferences by, for at least one preference category of the plurality of preference categories, one user preference of the plurality of user preferences or one operator preference of the plurality of operator preferences.
